(19) United States
(12) Patent Application Publication
(10) Pub. No.: US 2016/0248249 A1
(43) Pub. Date: Aug. 25, 2016

(54) ENERGY MANAGEMENT PROXY CONTROLLER SYSTEM

(71) Applicant: QUALCOMM Incorporated, San Diego, CA (US)

(72) Inventors: Peerapol Tinnakornsrisuphap, San Diego, CA (US); Rashid Ahmed Akbar Attar, San Diego, CA (US); Robert Sean Daley, Del Mar, CA (US); William Henry Von Novak, III, San Diego, CA (US); John David Boyd, San Diego, CA (US); Christopher Rudolf Wingert, Del Mar, CA (US)

(21) Appl. No.: 14/923,100

(22) Filed: Oct. 26, 2015

Related U.S. Application Data
(60) Provisional application No. 62/120,250, filed on Feb. 24, 2015.

(51) Int. Cl. H02J 3/00; H04W 4/00; G05B 15/02

(52) U.S. Cl. CPC H02J 3/00; G05B 15/02; H04W 4/008

(57) ABSTRACT

Mechanisms and techniques for managing devices within an energy management system are disclosed. In one embodiment, the energy management system includes a first controller and a second controller that control communications with and manage devices. The first controller determines to transmit a system management application instruction to a device and converts the system management application instruction to a device controller instruction based on an identifier of the device. The first controller generates a system message that includes the device controller instruction and formats the system message based on a network transmission format. The second controller receives the system message from the first controller and reformats the system message based on a device controller interface format. The second controller transmits the reformatted system message to a controller interface of the device.

### RELATED APPLICATIONS

This application claims priority benefit of Provisional United States of America Application No. 62/120,250 filed Feb. 24, 2015.

### TECHNICAL FIELD

Embodiments of the disclosed subject matter generally relate to the field of energy device management, and, more particularly, to systems and methods for enabling connectivity between a system controller and an ad hoc network of generator and load devices.

### BACKGROUND

Technological advances and energy market forces have contributed to a growing prevalence of on-site energy management systems, such as those implemented in homes and other buildings, Such energy management systems may include components for implementing centralized control of generator devices and load devices. Local energy management systems can balance local energy consumption levels with available local and remote energy supplies. To increase efficiency, this balancing preferably accounts for many factors including power generation from variable energy generator devices (e.g., photovoltaic panels).

Networking technologies are used for managing and coordinating energy management system devices, such as household appliances, Network automation systems may provide network-level and application-level communication for enabling centralized management of various subsystems and/or devices within the network, For example, devices may be communicatively connected within a local area network to enable centralized control by a system controller.

Technology is being developed to address the connectivity requirements of localized energy management systems. Such connectivity should include application-level message/command processing and network/transmission protocols. Example communication standards/specifications include the ZigBee Alliance Smart Energy Profile (SEP) 2.0 specification. The SEP 2.0 specification standardizes many requirements of a smart energy ecosystem including device communication, connectivity, and command information sharing.

Some network devices and subsystems may not support centralized, coordinated management. Given the vast categories of new and legacy electronic devices, energy management systems continue to face system integration issues.

### SUMMARY

This disclosure describes various embodiments for managing devices within an energy management system. In one embodiment, the energy management system includes a first controller and a second controller that control communications with and manage devices. The first controller determines to transmit a system management application instruction to a device and converts the system management application instruction to a device controller instruction based on an identifier of the device. The first controller generates a system message that includes the device controller instruction and formats the system message based on a network transmission format. The first controller transmits the system message to the second controller. The second controller receives the system message from the first controller and reformats the system message based on a device controller interface format. The second controller transmits the reformatted system message to a controller interface of the device.

### BRIEF DESCRIPTION OF THE DRAWINGS

The present embodiments may be better understood by referencing the accompanying drawings.

FIG. 1 is a block diagram depicting a networked electrical energy environment, according to some embodiments

FIG. 2 is a block diagram illustrating a controller device, according to some embodiments;

FIG. 3 is a block diagram depicting a proxy controller and an EMS controller, according to some embodiments;

FIG. 4 is a flow diagram depicting operations for configuring an EMS controller with an instruction conversion application, according to some embodiments;

FIG. 5 is a flow diagram depicting operations for managing devices within an energy management system, according to some embodiments; and

FIG. 6 depicts an example computer system for implementing embodiments of this disclosure.

### DESCRIPTION OF EMBODIMENT(S)

The description that follows includes example systems, methods, techniques, instruction sequences and computer program products that embody techniques of the subject matter disclosed herein. However, it is understood that the described embodiments may be practiced without these specific details. In other instances, well-known instruction instances, protocols, structures and techniques have not been shown in detail in order not to obfuscate the description.

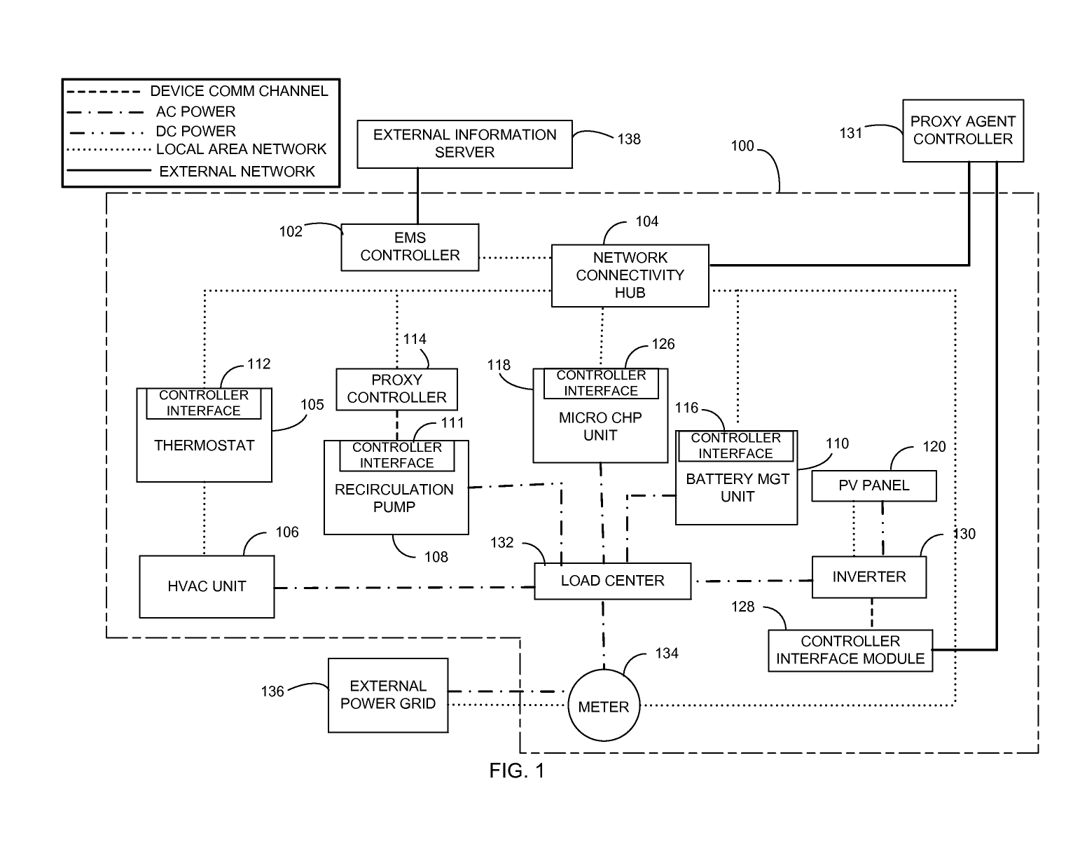

FIG. 1 is a block diagram depicting a networked electrical energy environment, according to some embodiments. In FIG. 1, the networked electrical energy environment includes an energy management system (EMS) 100 and an external power grid 136. The EMS 100 comprises multiple interconnected energy-generating devices (generator devices) and energy-consuming devices (load devices). The EMS 100 may be implemented within a home, office, hospital, business, etc. The EMS 100 may increase energy consumption efficiency, and decrease energy costs.

As shown in FIG. 1, the EMS 100 is connected to the external power grid 136, which may be connected to one or more energy sources, such as electric power plants (not depicted). The EMS 100 may exchange electrical power with the external power grid 136. A meter 134 can monitor this power exchange. The EMS 100 includes an EMS controller 102. The EMS controller 102 is a centralized energy controller for various energy-related devices associated with the EMS 100.

The solid, dotted, dashed, and dot-dashed lines in FIG. 1 represent communication and power transfer connections between components depicted in FIG. 1. The single dot-dashed lines represent alternating current (AC) power transfer. The double dot-dashed lines represent direct current (DC) power transfer. The dotted lines represent local area network (LAN) communication channels between devices. The solid lines represent external network communication paths between the EMS and devices external to the EMS. The dashed lines represent a device communication channel, which may be a serial or USB connection to the controlled device, or some other communication protocol. The power connections and communication channels may be unidirectional or bi-directional. Devices (e.g., thermostat 105) may use the communication channels to convey operational state information to the EMS controller 102. The devices may determine whether to update their operational states based, at least in part, on data and/or control instructions received from the EMS controller 102.

The EMS 100 further includes a heating, ventilation, and air conditioning (HVAC) unit 106 as a load device. The HVAC unit 106 provides temperature control within an area, such as a home. Activation of the HVAC unit 106 is controlled by the thermostat 105, which is configured to monitor the operational state of the HVAC unit 106 with respect to air temperature. The thermostat 105 may receive operation and scheduling control instructions from the EMS controller 102. The control instructions enable the operational activity of the HVAC unit 106 to be coordinated with the operation of generator devices and other load devices within the EMS 100.

The EMS 100 comprises other load devices, including a recirculation pump 108 and a battery management unit 110. The recirculation pump 108 may be a constant or variable speed pump used to circulate water (e.g., in a swimming pool). The battery management unit 110 may be electrically connected to a battery (not depicted), which serves as a local electrical energy reserve within the EMS 100. The battery management unit 110 may monitor, charge, and discharge one or more batteries. The battery management unit 110 may also report information about a battery to the EMS controller 102. For example, the battery management unit 110 may report a battery's stored charge amount, instantaneous charging rate, instantaneous discharging rate, recorded charging levels, charge levels, and charge rates.

The EMS 100 may supplement energy received from the external power grid 136 with locally generated energy from energy generator devices. In the depicted embodiment, the EMS 100 includes two example local energy generator devices: a photovoltaic (PV) panel 120 and a micro combined heating and power (CHP) unit 118. The PV panel 120 is controlled, in part, by an inverter 130, which also functions to convert the DC power generated by the PV panel 120 into AC power. The inverter 130 may implement maximum power point tracking and/or other techniques to improve utilization of the PV panel 120. The inverter 130 may report, to the EMS controller 102, an instantaneous and/or recorded energy generation rate (e.g., power measured in kW). The inverter 130 may also report other power generation parameter data associated with the operational state of the PV panel 120. In some embodiments, the inverter 130 receives control instructions from the EMS controller 102.

The micro CHP unit 118 may utilize fuel to generate power while simultaneously generating recoverable heat for an enclosure, such as a home. The micro CHP unit 118 may report an instantaneous and/or recorded energy generation rate and other parameters to the EMS controller 102. The EMS controller 102 may change the operational state of the micro CHP unit 118 based on power consumption needs and power output limitations of the devices and/or the overall system.

As described above, the meter 134 monitors energy transferred between the external power grid 136 and the EMS 100. A load center 132 may receive AC power from the external power grid 136 through the meter 134 and may distribute this power to various load devices (e.g., the HVAC unit 106 and the recirculation pump 108) and energy reserves, such as a battery. The load center 132 may also receive AC power from local energy sources, such as the micro CHP unit 118 and the inverter 130. In addition, the load center 132 may provide access for manually activating and deactivating load and generator devices.

The load devices (e.g., the HVAC unit 106, the recirculation pump 108, and the battery management unit 110) and the generator devices (e.g., the micro CHP unit 118 and the PV panel 120) may be collectively referred to as terminal devices. To facilitate connectivity within the EMS 100, one or more of the terminal devices may include controller interfaces. In the depicted embodiment, the thermostat 105, the micro CHP unit 118, and the battery management unit 110 each include controller interfaces 112, 126, and 116, respectively. In one embodiment, each of the controller interfaces 112, 126, and 116 includes network communication interface functionality. The network communication interface functionality enables the thermostat 105, the micro CHP unit 118, and the battery management unit 110 to communicate with the EMS controller 102 via a network connectivity hub 104. In some embodiments, the EMS controller 102 and network connectivity hub 104 may be implemented in the same device, while in other embodiments, they may be separate devices. For example, the network interface functionality within the controller interfaces 112, 126, and 116 may be Wi-Fi® functionality.

As further depicted in FIG. 1, the EMS controller 102 is communicatively connected with the load and generator devices via the network connectivity hub 104. In some embodiments, the network connectivity hub 104 may be implemented as a router having Wi-Fi capability. The network connectivity hub 104 may function to enable the EMS controller 102 to communicate with the various load devices (e.g., the HVAC unit 106) and generator devices (e.g., the PV panel 120). The load and generator devices, together with the EMS controller 102, form a local area network (LAN). The LAN can use any suitable communication protocols including Wi-Fi, Bluetooth®, powerline communication (PLC), Zigbee®, Z-Wave, Ethernet, etc. The EMS controller 102 may also include an external network interface for communicating with an external information server 138 and other devices.

Each device's controller interface 112, 126, and 116 may be connected with a microcontroller and memory of the device. The device's memory may include device controller instructions for controlling the device. For example, the devices memories can include device controller instructions for controlling the thermostat 105, the micro CHP unit 118, and the battery management unit 110. For example, the device controller instructions can directly actuate and coordinate mechanical, electrical, and logical operations of the thermostat 105, and other terminal devices. In one embodiment, the device controller instructions may include a system management application client that cooperates with a system management application that is hosted by the EMS controller 102.

The system management application client may be stored within the controller interfaces 112, 126, and 116. The system management application client may be an application program or suite of programs conforming to a standards, such as the ZigBee Alliance SEP2.0 specification. The SEP 2.0 specification specifies an application layer for supporting communication between smart energy devices within a local area network. The EMS controller 102 may include a system management application that communicates across a LAN with system management application clients to manage the thermostat 105, the micro CHP unit 118, and the battery management unit 110. The LAN may utilize Wi-Fi. The LAN may also utilize a system management application for application-level message/command processing. Alternatively, the LAN may utilize wireline technology, such as a PLC protocol, an Ethernet protocol, etc.

One or more of the terminal devices within the EMS 100 may not be directly connected or otherwise logically associated with a LAN hosted by the EMS controller 102. For example, the recirculation pump 108 may include a controller interface 111 that does not include a network interface for communicating with the EMS controller 102 via a LAN. Furthermore, the recirculation pump's controller interface 111 may not include a system management application client compatible with the system management application hosted by the EMS controller 102. As shown in FIG. 1, a proxy controller 114 may be utilized in conjunction with the EMS controller 102 to manage and coordinate the operation of the recirculation pump 108. In one embodiment, the proxy controller 114 is connected to the controller interface 111 via a device connection, such as a serial connection. The proxy controller 114 and the EMS controller 102 can communicate via the network connectivity hub 104.

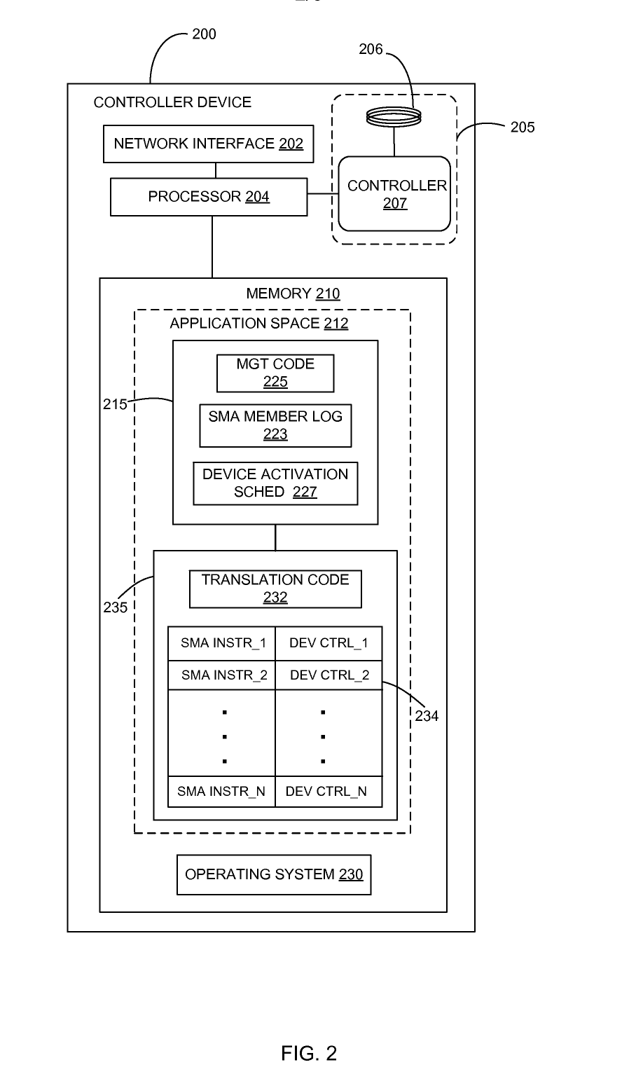

As depicted and explained in further detail with reference to FIGS. 2-5, the EMS controller 102 may further store and execute an instruction conversion application. In some embodiments, the instruction conversion application combined with the communication interface provided by the proxy controller 114 enables the EMS controller 102 to manage operations of the recirculation pump 108.

In some instances, the terminal devices may utilize external controller interface modules that do not have LAN interface functionality. For example, as depicted in FIG. 1, the inverter 130 may be connected with a controller interface module 128 which may be external to the inverter 130. The controller interface module 128 may not have network access to the LAN communication channels over which the EMS controller 102 communicates with and controls the terminals devices. Instead, as depicted in FIG. 1, the controller interface module 128 may communicate with a proxy agent controller 131 over an external network, such as a cellular communication network. Furthermore, the controller interface module 128 may not include a system management application client. In one embodiment, the proxy agent controller 131 may provide network connectivity (e.g., Internet connectivity) between controller interface module 128 and the EMS controller 102.

The proxy agent controller 131 may be discovered by the EMS controller 102 and/or by the controller interface module 128. In one embodiment, the EMS controller 102 and/or the controller interface module 128 may use a device identifier (e.g., model or serial number) to locate the proxy agent controller 131 over an external network such as the Internet. In one embodiment, the EMS controller 102 and/or the controller interface module 128 may send a security code over the external network to obtain operational access to the proxy agent controller 131.

Embodiments of the EMS controller 102 may include a memory that stores computer-executable instructions for performing the tasks and functionalities described herein. The EMS controller 102 may further include and/or communicate with a system management application (not shown in FIG. 1) which may include program instructions and data associated with power and energy consumption parameters, configuration, and activation schedules of the terminal devices. The system management application will be described in further detail with reference to FIG. 2.

FIG. 2 is a block diagram illustrating a controller device, according to some embodiments. In some embodiments, the EMS controller 102, the proxy controller 114, and/or the proxy agent controller 131 can include components and functionality described vis-à-vis FIG. 2. In some embodiments, a controller device 200 is a “smart” controller, having features extending beyond those associated with interface-specific computer controllers. Although not shown, the controller device 200 can include user input/output systems, displays, and/or other suitable components. In FIG. 2, the controller device 200 includes a network interface 202, which may be a wireless or wireline interface for communicating with an external information server across a network, such as the Internet. The controller device 200 further includes a processor 204 and memory 210. The memory 210 and the processor 204 cooperatively function to manage programs and data that enable the controller device 200 to perform various energy management tasks associated with local power generator and load devices.

The controller device 200 further includes a communication interface 205. The communication interface 205 may comprise one or more interfaces capable of supporting Wi-Fi, Zigbee, Bluetooth, etc. The communication interface 205 includes an interface controller 207 for communicating with various power generator and load devices directly or via a hub (e.g., the network connectivity hub 104 in FIG. 1). The communication interface 205 also includes an antenna 206 for wirelessly connecting with the terminal devices.

The memory 210 comprises a non-transitory computer-readable storage medium that stores programs and data that control operations of the controller device 200. In the depicted embodiment, the memory 210 stores an operating system (OS) 230 and includes an application space 212. The OS 230 may be a flexible, multi-purpose OS such as that found in smartphones, or may be an embedded OS having more limited and specialized functionality. The OS 230 comprises code for managing and providing services to hardware and software components within the controller device 200. Among other code and instructions, the OS 230 includes process management code comprising instructions for interfacing application code with system hardware and software. The OS 230 further includes memory management code for allocating and managing the memory 210 for use by application and system-level programs. The OS 230 further includes I/O system management code including device drivers that enable the controller's hardware to communicate with external systems, such as a user's smartphone.

In one embodiment in which the controller device 200 functions as an EMS controller, the application space 212 may maintain a system management application 215. The system management application 215 contains management code 225 (computer executable instructions) and data including power and energy parameters, configuration, and activation schedules of generator and load devices within an energy management system. For example, the management code 225 may be SEP 2.0 application code including program instructions and data for coordinating and scheduling the activation, deactivation, power generation, power consumption, and other operational conditions of generator and load devices.

The system management application 215 may further comprise a device activation schedule 227 that includes scheduling information, such as activation schedules for terminal devices. The information within the device activation schedule 227 may be generated and utilized by instructions within the management code 225. In some embodiments, the management code may take user preferences into account, such as temperature comfort ranges for the HVAC activation schedule. During execution of the management code 225, the controller device 200 can process the scheduling information to generate system management application instructions that are transmitted to one or more terminal devices.

The controller device 200 may be configured as an EMS controller capable of translating data/commands between the system management application data/command format, and a device controller data/command format. In such an embodiment, an instruction conversion application 235 may be linked to or otherwise logically associated with the system management application 215. The instruction conversion application 235 may enable the controller device 200 to translate, map, or otherwise convert instructions and data between a system management application format and a device controller format.

The system management application 215 may further include a system management application member log 223. The system management application member log 223 may record data that identifies one or more terminal devices as being included in a system management application network. The system management application network comprises devices (i.e., terminal devices, EMS controller, etc.) that include a system management application or system management application client. The system management application member log 223 may include a device identifier and a member flag to indicate whether a terminal device belongs to a system management application network. If asserted, the member flag indicates that the terminal device's controller interface includes a system management application client. In one embodiment, the system management application member log 223 may record data that identifies one or more terminal devices, such as the recirculation pump 108, as not belonging to a system management application network. For example, the system management application member log 223 can include a device identifier for the recirculation pump 108 associated with an un-asserted member flag to indicate that the recirculation pump 108 is not included within the system management application network. The system management application member log 223 may be overridden, in this case, not all capable terminal devices in the system need be controlled.

In one embodiment, the instruction conversion application 235 includes translation code 232 and a translation table 234. The translation table 234 may include data entries that associatively map instructions in a command/data format used by the system management application 215 to a command/data format used by device controllers. For example, and as shown in FIG. 2, the translation table 234 includes N row-wise entries that each logically associate a system management application instruction (e.g., SMA INSTR_1) with a device controller instruction (e.g., DEV CTRL_1). The translation code 232 includes program instructions that, when executed by the processor 204, may process the mapping associations within the translation table 234. In one embodiment, the translation code 232 uses the mapping associations within the translation table 234 to translate instructions in the system management application format to instructions in the device controller format. Alternatively, the translation code 232 may translate instructions in the device controller format to instructions in the system management application format.

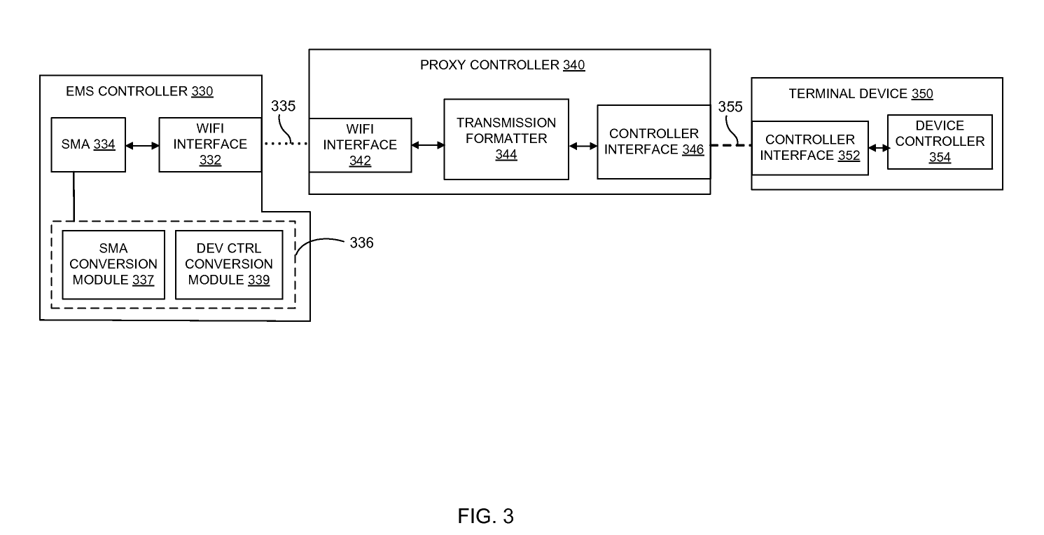

FIG. 3 is a block diagram depicting a proxy controller and an EMS controller, according to some embodiments. As shown in FIG. 3, an EMS controller 330 comprises a system management application 334 which is executed to generate system messages containing system management application instructions in accordance with a given programmed system operation and scheduling mode. The system management application 334 may conform to a particular system management specification and includes a format with conforming protocols, data structures, and instruction semantics by which the EMS controller 330 can communicatively manage terminal devices sharing the same or a logically conformant system management application.

FIG. 3 is a block diagram illustrating a terminal device, according to some embodiments. FIG. 3 shows a terminal device 350 that does not include a system management application client. Because the terminal device 350 does not include a system management application client, the terminal device 350 cannot process system management application instructions. In one implementation, the terminal device 350 may be the recirculation pump 108 (see FIG. 1). Furthermore, the terminal device 350 may not include a network interface by which it can connect to a Wi-Fi network and communicate with the EMS controller's Wi-Fi interface 332. As shown, the terminal device 350 includes a controller interface 352, which can include a USB communication port, or other suitable communication port (e.g., an RS-232 port). The terminal device 350 further comprises a device controller 354 that receives instructions and data via the controller interface 352. The device controller 354 may include a microcontroller, microprocessor, memory and instructions for managing mechanical, electrical, and logical operational elements of the terminal device 350.

In the depicted embodiment, an EMS controller 330 includes an instruction conversion application 336. The instruction conversion application 336 combined with transmission reformatting provided by the proxy controller 340, enables the EMS controller 330 to control operations of and receive information from the terminal device 350. The instruction conversion application 336 may comprise a system management application conversion module 337 and a device control conversion module 339.

As shown in FIG. 3, the proxy controller 340 includes a Wi-Fi interface 342 for communicating with the EMS controller 330, and a controller interface 346 for communicating with the terminal device 350. A Wi-Fi link 335 communicatively couples the proxy controller's Wi-Fi interface 342 with the EMS controller's Wi-Fi interface 332. A wireline interconnect 355 communicatively couples the proxy controller's controller interface 346 with the terminal device's controller interface 352.

In one embodiment, the EMS controller 330 may determine to transmit a system management application instruction to the terminal device 350. Before generating the system management application instruction, the EMS controller 330 accesses a system management application membership log (e.g., system management application member log 223) to determine whether the terminal device 350 includes a system management application client. If the terminal device does not include a system management application client, the system management application 334 utilizes the system management application conversion module 337.

In one embodiment, the system management application conversion module 337 converts the system management application instruction from a system management application format to a device controller instruction in a device controller format. To convert the instructions, the system management application conversion module 337 may execute translation code (e.g., translation code 232) and access an internally stored translation table (e.g., translation table 234). The EMS controller 330 then adds the converted system management application instruction to a message formatted according to a network transmission format, such as TCP/IP. The EMS controller 330 transmits the message (including converted system management application instruction) from its Wi-Fi interface 332 to the proxy controller's Wi-Fi interface 342.

As further depicted in FIG. 3, the proxy controller 340 includes a transmission formatter 344 that may reformat messages received from the Wi-Fi interface 342 to be compatible with the communication formatting of the controller interface 346. The transmission formatter 344 may also reformat messages received from the controller interface 346 to be compatible with the transmission formatting of the Wi-Fi interface 342. In one embodiment, a message is received at the Wi-Fi interface 342 and processed by the transmission formatter 344 to replace the network transmission format (e.g., Wi-Fi) with a device transmission format (e.g., USB). The controller interface 346 transmits the message, which includes the converted system management application instruction, across the wireline interconnect 355 to the terminal device's controller interface 352.

The terminal device's controller interface 352 transmits the system message to the device controller 354 for processing. In response to processing the system message, the device controller 354 may transmit a response message across the wireline interconnect 355 to the controller interface 346. The response message may include data and/or instructions formatted in accordance with the instruction semantics and data structure types conforming to the native instruction set of the device controller 354. The proxy controller 340 may process the response message using the transmission formatter 344. The transmission formatter 344 may include program instructions for reformatting the response message from a device transmission format (e.g., USB) to a network transmission format (e.g., TCP/IP). The proxy controller's Wi-Fi interface 342 transmits the reformatted response message to the EMS controller's Wi-Fi interface 332. The EMS controller 330 can process the response message using the device control conversion module 339. The device control conversion module 339 may reformat the response message received by the controller interface 346 from the terminal device 350. For example, the device control conversion module 339 can convert the device controller format into the system management application format.

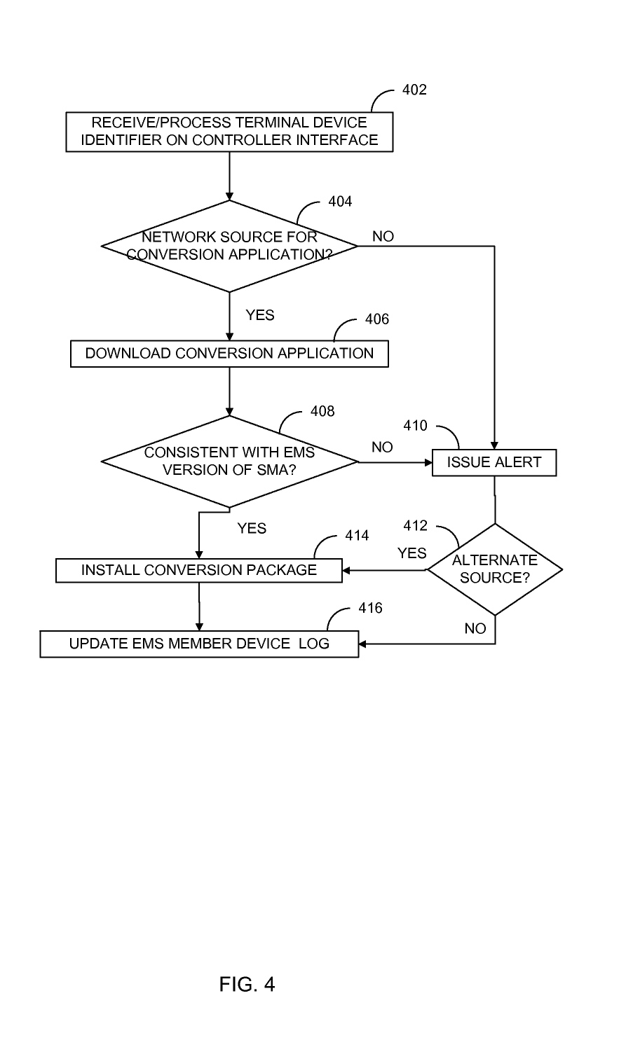

Before an EMS controller can perform the operations described above, it may perform configuration operations. FIG. 4 is a flow diagram depicting operations for configuring an EMS controller with an instruction conversion application, according to some embodiments. The instruction conversion application includes code for converting between instruction formats, such as converting between an instruction format native to a system management application to an instruction format native to a terminal device's device controller.

The process begins at block 402 with the EMS controller receiving, from a proxy controller, a terminal device ID for a terminal device to which the proxy controller is connected. In one embodiment, the terminal device ID may be a device model code or a device serial number which may be obtained from a device barcode. Based on the terminal device ID, the EMS controller determines whether an instruction conversion application is available from a network source, such as an information server (block 404). For example, the EMS controller may utilize the terminal device ID to discover from network sources whether an instruction conversion application is available from one or more network servers. In response to determining that an instruction conversion application is available, the EMS controller requests and obtains the instruction conversion application from the network source (block 406). In one embodiment, the EMS controller downloads the instruction conversion application form the network source.

Proceeding at block 408, the EMS controller determines whether the instruction conversion application will cooperate with the EMS controller's system management application version. If the obtained instruction conversion application will cooperate with the hosted system management application, the EMS controller installs the instruction conversion application (block 414). The EMS controller may also update its locally stored system management application membership log accordingly (block 416).

At block 404, if the network sourced instruction conversion application will not cooperate with the hosted system management application, the EMS controller issues a system alert (block 410), and checks for an alternative source for an instruction conversion application (block 412). In response to locating an alternative source, the EMS controller installs the conversion application (block 414).

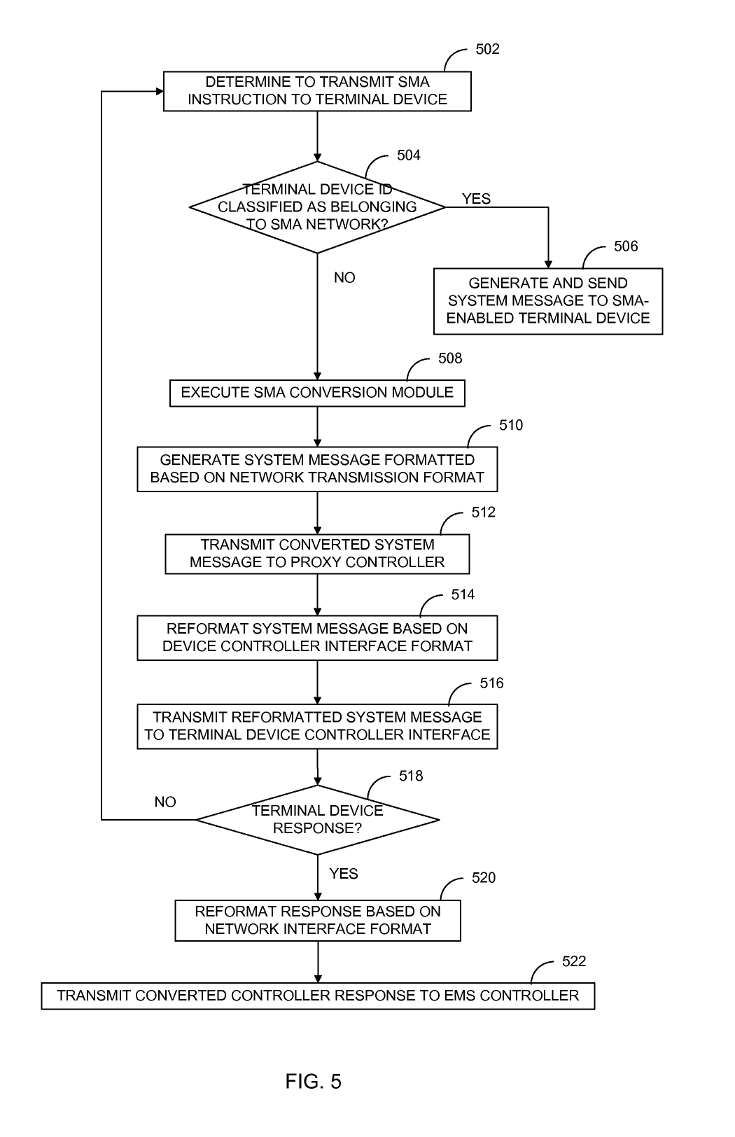

FIG. 5 is a flow diagram depicting operations for managing devices within an energy management system, according to some embodiments. The operations begin at block 502, where an EMS controller determines to transmit a system management application instruction to a terminal device. At block 504, The EMS controller may access a system management application membership log to determine whether the terminal device is included in a system management application network (i.e., whether the terminal device includes a system management application client). If the terminal device is included in the system management application network, the flow continues at block 506. At block 506, the EMS controller generates and transmits the system management application instruction to be processed by the terminal device (block 506).

If the terminal device is not included in a system management application network (e.g., does not include a system management application client), the flow continues at block 508. At block 508, the EMS controller executes a system management application conversion module to convert the system management application instruction to a device controller instruction. At block 510, the EMS controller generates a system message in which to include the converted instruction, and formats the system message based on a network transmission format (e.g., TCP/IP).

At block 512, The EMS controller transmits the system message to a proxy controller. At block 514, the proxy controller reformats the system message based on a device controller interface format (e.g., USB). At block 516, the proxy controller transmits the reformatted system message to a terminal device's controller interface. If no response is received from the terminal device (block 518), the process returns to block 502. If a response message is received from the terminal device (block 518), the proxy controller reformats the response message from a device transmission format to a network transmission format (block 520). The proxy controller may then transmit the converted response message to the EMS controller as shown at block 522. In some embodiments, the process may return to block 502 following block 522.

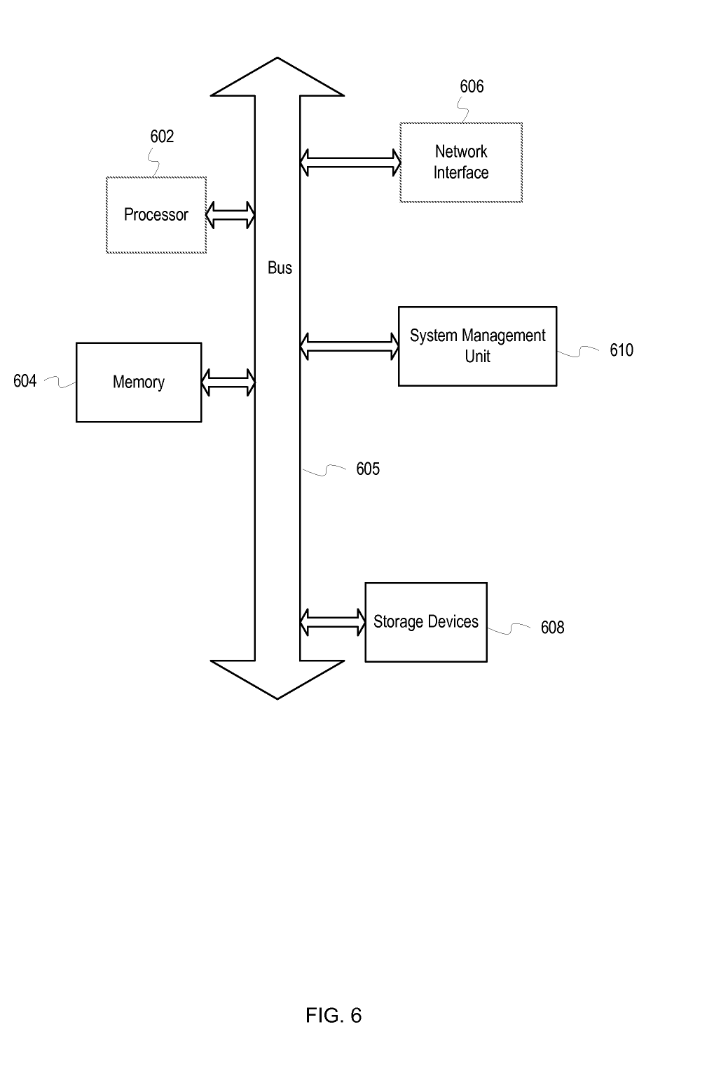

FIG. 6 depicts an example computer system for implementing embodiments of this disclosure In FIG. 6, the computer system includes a processor 602 that may include multiple processors, multiple cores, and/or multiple nodes. The computer system includes memory 604 which may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of non-transitory computer-readable media. The computer system also includes a bus 605 (e.g., PCI, ISA, PCI-Express, HyperTransport®, InfiniBand®, NuBus, etc.), a network interface 606 (e.g., an Ethernet interface, a Frame Relay interface, Synchronous Optical Networking interface, wireless interface, etc.), and a storage device(s) 608 (e.g., optical storage, magnetic storage, etc.). The system management unit 610 includes components (e.g., hardware, instructions, etc.) to implement functionality described above with reference to FIGS. 1-5. The system management unit 610 may perform operations that facilitate management of energy management system devices including load and generator devices. The system management unit 610 may perform system management operations including configuring proxy controllers to facilitate communications with terminal devices. These operations may be partially (or entirely) implemented in hardware and/or on processor 602. For example, the functionality may be implemented with an application specific integrated circuit, in logic implemented in processor 602, in a co-processor on a peripheral device or card, etc. Further, realizations may include fewer or additional components not illustrated in FIG. 6 (e.g., additional network interfaces, peripheral devices, etc.).

As will be appreciated by one skilled in the art, aspects of the disclosed subject matter may be embodied as a system, method or computer program product. Accordingly, embodiments of the disclosed subject matter may take the form of an entirely hardware embodiment, an entirely software embodiment (including firmware, resident software, micro-code, etc.) or an embodiment combining software and hardware aspects that may all be referred to herein as a “circuit,” “module,” or “system.” Furthermore, embodiments of the disclosed subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

It should be understood that FIGS. 1-6 are examples meant to aid in understanding embodiments and should not be used to limit embodiments or limit scope of the claims. Embodiments may perform additional operations, fewer operations, operations in a different order, operations in parallel, and some operations differently. For example, in some embodiments, load devices in an EMS may include electric waters heaters and/or an electric vehicle. In some embodiments, an EMS controller and/or a proxy controller can implement the operations of FIGS. 4 and 5 individually or in combination.

What is claimed is:

1. A method for managing devices within an energy management system comprising a first controller and a second controller, the method comprising:
determining, by the first controller, to transmit a system management application instruction to a device;
determining whether the device is a member of a system management application network;
in response to determining the device is not a member of the system management application network:
converting the system management application instruction to a device controller instruction;
generating a system message that comprises the device controller instruction, wherein the system message is formatted based, at least in part, on a network transmission format; and
transmitting the system message to the second controller; and
in response to determining the device is a member of the system management application network:
transmitting the system management application instruction to a controller interface of the device.

2. The method of claim 1 further comprising:
receiving, at the first controller, a reformatted response message from the second controller, the reformatted response message based, at least in part, on the network transmission format and a response message from the device.

3. The method of claim 1, wherein converting the system management application instruction comprises mapping the system management application instruction to the device controller instruction.

4. The method of claim 1, wherein converting the system management application instruction comprises:
receiving a device identifier from the second controller;
determining a network source for obtaining an instruction conversion application based, at least in part, on the device identifier; and
requesting the instruction conversion application from the network source.

5. The method of claim 4, wherein the device identifier comprises at least one member of the group consisting of:
a device model; and
a device serial number.

6. The method of claim 4 further comprising:
obtaining the instruction conversion application from the network source; and
installing the instruction conversion application in a memory.

7. The method of claim 4, wherein the instruction conversion application comprises at least one table having data entries associatively mapped between system management application instructions in a system management application format and device controller instructions in a device controller format.

8. The method of claim 4, wherein the instruction conversion application comprises translation code that translates device controller instructions to system management application instructions.

9. A first controller within an energy management system, the first controller comprising:
a processor; and
a memory comprising instructions that, when executed by the processor, cause the first controller to perform operations comprising:
determining to transmit a system management application instruction to a device;
in response to determining the device is not a member of a system management application network:
converting the system management application instruction to a device controller instruction;
generating a system message that comprises the device controller instruction, wherein the system message is formatted based, at least in part, on a network transmission format; and
transmitting the system message to a second controller; and
in response to determining the device is a member of the system management application network:
transmitting the system management application instruction to a controller interface of the device.

10. The first controller of claim 9, the operations further comprising:
receiving a reformatted response message from the second controller, the reformatted response message based, at least in part, on the network transmission format and a response message from the device.

11. The first controller of claim 9, wherein converting the system management application instruction comprises mapping the system management application instruction to the device controller instruction.

12. The first controller of claim 9, the operations further comprising:
receiving a device identifier from the second controller;
determining a network source for obtaining an instruction conversion application based, at least in part, on the device identifier; and
requesting the instruction conversion application from the network source.

13. The first controller of claim 12, the operations further comprising:
obtaining the instruction conversion application from the network source; and
installing the instruction conversion application in the memory of the first controller.

14. The first controller of claim 12, wherein the instruction conversion application comprises at least one table having data entries associatively mapped between system management application instructions in a system management application format and device controller instructions in a device controller format.

15. The first controller of claim 12, wherein the instruction conversion application comprises translation code that translates device controller instructions to system management application instructions.

16. A method for managing devices within an energy management system comprising a first controller and a second controller, the method comprising:
receiving, by the first controller from the second controller, a system message comprising a device controller instruction based, at least in part, on a system management application instruction, the system message formatted based, at least in part, on a network transmission format;
reformatting the system message based, at least in part, on a device controller interface format; and
transmitting the reformatted system message to a controller interface of a device.

17. The method of claim 16, further comprising:
receiving, by the first controller, a response message from the device;
reformatting the response message based, at least in part, on the network transmission format; and
transmitting the reformatted response message to the second controller.

18. The method of claim 16, further comprising:
transmitting a device identifier to the second controller, the device identifier for discovering a network source for obtaining an instruction conversion application.

19. A first controller within an energy management system, the first controller comprising:
a processor; and
a memory comprising instructions that, when executed by the processor, cause the first controller to perform operations comprising:
receiving, from a second controller, a system message comprising a device controller instruction based, at least in part, upon a system management application instruction, the system message formatted based, at least in part, on a network transmission format;
reformatting the system message based, at least in part, on a device controller interface format; and
transmitting the reformatted system message to a controller interface of a device.

20. The first controller of claim 19, the operations further comprising:
receiving a response message from the device;
reformatting the response message based, at least in part, on the network transmission format; and
transmitting the reformatted response message to the second controller.

21. The first controller of claim 19, the operations further comprising:
transmitting a device identifier to the second controller, the device identifier for discovering a network source for obtaining an instruction conversion application.

22. A first controller, comprising:
means for determining to transmit a system management application instruction to a device;
means for determining whether the device is a member of a system management application network;
in response to determining the device is not a member of the system management application network:
means for converting the system management application instruction to a device controller instruction;
means for generating a system message that comprises the device controller instruction, wherein the system message is formatted based, at least in part, on a network transmission format; and
means for transmitting the system message to a second controller; and
in response to determining the device is a member of the system management application network:
means for transmitting the system management application instruction to a controller interface of the device.

23. The first controller of claim 22, further comprising:
means for receiving a reformatted response message from the second controller, the reformatted response message based, at least in part, on the network transmission format and a response message from the device.

24. The first controller of claim 22, wherein the means for converting the system management application instruction to the device controller instruction comprises means for mapping the system management application instruction to the device controller instruction.

25. The first controller of claim 22, further comprising:
means for receiving a device identifier from the second controller;
means for determining a network source for obtaining an instruction conversion application based, at least in part, on the device identifier; and
means for requesting the instruction conversion application from the network source.

26. The first controller of claim 25, further comprising:
means for obtaining the instruction conversion application from the network source; and
means for installing the instruction conversion application in a memory of the first controller.

27. The first controller of claim 25, wherein the instruction conversion application comprises at least one table having data entries associatively mapped between system management application instructions in a system management application format and device controller instructions in a device controller format.

28. The first controller of claim 25, wherein the instruction conversion application comprises translation code that translates device controller instructions to system management application instructions.

29. A non-transitory computer-readable medium storing instructions that, when executed by one or more processors of a first controller, cause the first controller to:
determine to transmit a system management application instruction to a device;
determine whether the device is a member of a system management application network;
in response to the device being not a member of the system management application network:
convert the system management application instruction to a device controller instruction;
generate a system message that comprises the device controller instruction, wherein the system message is formatted based, at least in part, on a network transmission format; and
transmit the system message to a second controller; and
in response to the device being a member of the system management application network:
transmit the system management application instruction to a controller interface of the device.

30. The non-transitory computer-readable medium of claim 29, wherein execution of the instructions further causes the first controller to:
receive a reformatted response message from the second controller, the reformatted response message based, at least in part, on the network transmission format and a response message from the device.

31. The non-transitory computer-readable medium of claim 29, wherein execution of the instructions further causes the first controller to:
receive a device identifier from the second controller;
determine a network source for obtaining an instruction conversion application based, at least in part, on the device identifier; and
request the instruction conversion application from the network source.

32. The non-transitory computer-readable medium of claim 29, wherein execution of the instructions further causes the first controller to:
obtain an instruction conversion application from a network source; and
install the instruction conversion application in a memory.

33. A first controller comprising:
means for receiving, from a second controller, a system message comprising a device controller instruction based, at least in part, upon a system management application instruction, the system message formatted based, at least in part, on a network transmission format;
means for reformatting the system message based, at least in part, on a device controller interface format; and
means for transmitting the reformatted system message to a controller interface of a device.

34. The first controller of claim 33, further comprising:
means for receiving a response message from the device;
means for reformatting the response message based, at least in part, on the network transmission format; and
means for transmitting the reformatted response message to the second controller.

35. The first controller of claim 33, further comprising:
means for transmitting a device identifier to the second controller, the device identifier for discovering a network source for obtaining an instruction conversion application.

36. A non-transitory computer-readable medium storing instructions that, when executed by one or more processors of a first controller, cause the first controller to:
receive, from a second controller, a system message comprising a device controller instruction based, at least in part, on a system management application instruction, the system message formatted based, at least in part, on a network transmission format;
reformat the system message based, at least in part, on a device controller interface format; and
transmit the reformatted system message to a controller interface of a device.

37. The non-transitory computer-readable medium of claim 36, wherein execution of the instructions further causes the first controller to:
receive a response message from the device;
reformat the response message based, at least in part, on the network transmission format; and
transmit the reformatted response message to the second controller.

38. The non-transitory computer-readable medium of claim 36, wherein execution of the instructions further causes the first controller to:
transmit a device identifier to the second controller, the device identifier for discovering a network source for obtaining an instruction conversion application.
